(19) United States
(12) Patent Application Publication
(10) Pub. No.: US 2015/0112814 A1
(43) Pub. Date: Apr. 23, 2015

(54) SYSTEM AND METHOD FOR AN INTEGRATED CONTENT PUBLISHING SYSTEM

(71) Applicant: Salesforce.com, Inc., San Francisco, CA (US)

(72) Inventor: Patrick J. Stokes, Bronxville, NY (US)

(21) Appl. No.: 14/516,619

(22) Filed: Oct. 17, 2014

Related U.S. Application Data
(60) Provisional application No. 61/892,645, filed on Oct. 18, 2013.

(51) Int. Cl. G06Q 30/02; G06Q 50/00

(52) U.S. Cl. CPC G06Q 30/0276; G06Q 30/0269; G06Q 50/01
USPC 705/14.66

(57) ABSTRACT

Systems and techniques are disclosed for searching content on a social network computer system for a data item of interest and determining when the content on the social network computer system related to the data item of interest exceeds a relevancy threshold. An electronic media item object (e.g., a video, image, text) associated with the data item of interest may be obtained based on the determination. The electronic media item object may be modified to generate a modified electronic media item object. The modified electronic media item object may be approved and be provided to one or more targeted recipients.

### PRIORITY

This application claims the benefit of U.S. Provisional Application No. 61/892,645, filed Oct. 18, 2013, the disclosure of which is incorporated by reference in its entirety.

### BACKGROUND

Traditionally, individuals may determine what content is more popular based on a public poll or by determining that the given content has a threshold number of queries associated with it. However, the individual may not be aware of potentially popular content and, even if he is aware of the potentially popular content, the individual may not be able to utilize the popularity of the content as the rights to the content may belong to an entity other than the individual.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a computer according to an embodiment of the disclosed subject matter.

FIG. 2 shows a network configuration according to an embodiment of the disclosed subject matter.

FIG. 3 shows an example process for providing a modified electronic media item object to a targeted recipient, according to an embodiment of the disclosed subject matter.

FIG. 4 shows another example process for providing a modified electronic media item object to a targeted recipient, according to an embodiment of the disclosed subject matter.

### DETAILED DESCRIPTION

According to the techniques disclosed herein, a user may be able to determine content that is optimal to use to obtain a positive response from a target audience to whom the content is to be presented. As an example, an event organizer may need to determine what content attracts most people to an event to maximize promotional value of an advertisement intended to contain the content. The techniques disclosed herein enable the user to use social media network content to determine if a data item of interest (e.g., a topic, a category, etc.) has reached a threshold level of interest within the social media network computer system and identify a media item object (e.g., an image, a video, and the like) associated with the data item of interest, based on the level of interest and popularity. The identified media item object may be selected as it may elicit a positive response to a promotion or advertisement containing the media item. As a specific example, an athletic shoe company may initiate a search via one or more social media network to search references made, over the last two weeks, to basketball athletes. If a threshold number of references are made for an Athlete A then an image or video that contains Athlete A may be searched for and selected. Furthermore, the media item may be selected such that minimal or zero cost is incurred by selecting the media item from a public domain on a different source that provides the media item at minimal or zero cost. Continuing the example, the image or video of Athlete A may be from the public domain such that the athletic shoe company need not pay for the image or video to use it. The publicly available image or video may be modified to include text or images referring to the athletic shoe company and provided to the users who referenced basketball athletes.

In exemplary embodiments of the disclosure, and in the example provided above, if a threshold number of references are made for the Athlete A, then the image that contains Athlete A may be searched for and selected from one or more image or video repositories provided by another company or individual (e.g., AP Images®, Gettyimages®, Flickr®, Vine®, YouTube®, and the like). The repositories may be one or more databases that are stored on at least one digital storage device, and are accessible via a communications network. The athletic shoe company may have a subscription for images or video from a company, or may pay a royalty fee for use of one or more rights-managed images or video. At least one of the subscription fee agreement or the royalty fee arrangement associated with a rights-managed image or video may permit the athletic shoe company with the rights to modify a selected image or video to include text or images referring to the athletic shoe company and provided to the users who referenced basketball athletes. Alternatively or in addition, a company may maintain an internal database of acceptable images for use in marketing, which may be used in embodiments described herein.

The image repositories, whether kept internally or maintained and provided by another company or individual, may classify media item objects, allow the repository to be searched, and may provide additional tagging or classification data for each media item object. For example, a company may separately classify images and video in a repository. In the image repository, for example, the company may provide one or more classifications of images, such as news, sports, editorial, publicity, entertainment, politics, historical, and the like. Collections of images from a particular photographer also may be provided and classified. The image repository may have a different classification of images based on type, such as creative images (e.g., which may be sub-categorized into animals, people, travel, party, professional, and the like) and editorial (e.g., which may be sub-categorized into news, sports, entertainment, fashion, travel, and the like). The image repository may also classify images based on the time period during which they were created and/or added to the repository, such as classifying images based on whether they have been taken or added to the repository within, for example, the last hour, six hours, or 24 hours, and may have a separate classification for the most popular images of the image repository (e.g., based on number of views, use in media, or the like).

As disclosed above, in addition to being classified, the media item objects may have tagging or may include metadata that is searchable so that the media item object can be located. The tagging or metadata may include, for example, the subject of the image (e.g., names of any people in the image), the location (e.g., geographic location of the image, such as the country, state, city, or town where the image was taken, or the name of the park, building, or business in which the image was taken), and the genre of the image (e.g., sports, landscape, fashion, entertainment, politics, and the like).

In exemplary embodiments of the disclosure, and in the example provided above, if a threshold number of references are made for the Athlete A, then the image that contains Athlete A may be searched for and selected from one or more image repositories maintained by the athletic shoe company, which may include images of Athlete A and other athletes who are sponsored by the athletic shoe company. The images of Athlete A may be maintained by the athletic shoe company as part of Athlete A's sponsorship agreement. The image available in the athletic shoe company's image repository may be modified to include text referring to the athletic shoe company and provided to the users who referenced basketball athletes.

Images also may be classified based on industry-specific topics or classifications. For example, in an image repository of sponsored athletes that is maintained by the athletic shoe company, images may be classified according to athlete name, sport, competition subject matter, community service subject matter, public relations subject matter, charitable cause subject matter, and the like. For example, if a threshold number of references are made for the Athlete A are negative, the athletic shoe company can provide images of Athlete A having, for example, community service subject matter or charitable cause subject matter that can be modified to include text referring to the athletic shoe company, along with the charitable or community service work performed by Athlete A and the athletic shoe company, and provided to the users who referenced Athlete A (e.g., including those users who references Athlete A in a negative manner). In another example, in a promotion of a new athletic shoe being worn by Athlete A during competition, where the shoe might not yet be available to the public, the athletic shoe company may search for and provide an image of Athlete A using the new shoe in competition, with text added indicating, for example, the introduction date of the new shoe and where it will be available for purchase. This may occur when comments from users on the social network computing system regarding the new shoe itself, Athlete A's use of the new shoes in a particular competitive event, and the like has reached a threshold level of interest within the social media network computer system.

As another specific example, a user planning a conference event with multiple keynote speakers can determine which, if any, of the keynote speaker has reached a level of interest by searching content on a social media network computer system. An image of a keynote speaker that meets a threshold may be searched for in the public domain. An image from the public domain may be modified and provided to individuals that may be interested in the conference event. The modified image may be well received by the individuals it is presented to as a result of the keynote speaker's popularity, as determined based on the searched content of social media network computer system.

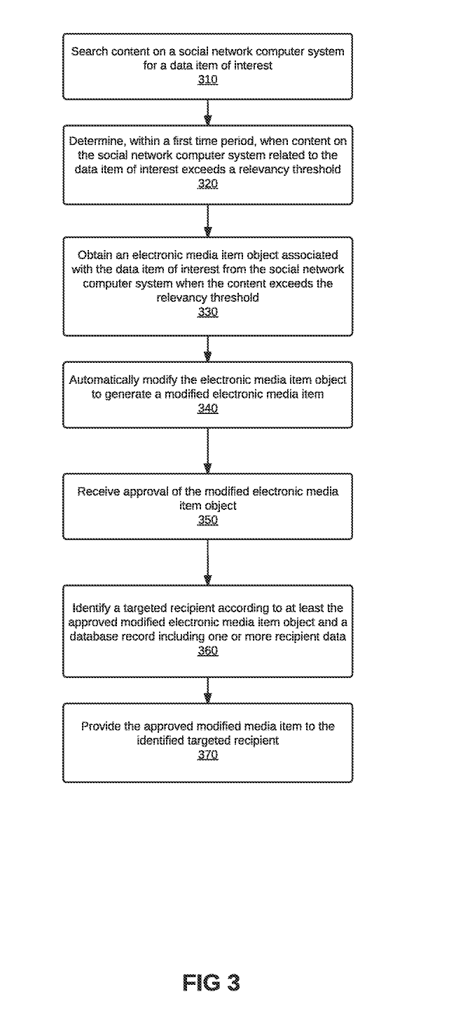

According to embodiments of the disclosed subject matter, as shown at step 310 in FIG. 3, content on a social media network computer system may be searched for a data item of interest. Content of various social media networks (e.g. Facebook®, Instagram®, Twitter®, LinkedIn®, etc.) may be available to be searched. A search of a social media network computer system may include a search of all content (e.g., text, images, video, graphics, etc.), affirmative actions or comments towards content (e.g., a like, a selection, a comment, an affirmative indicator, etc.), or the like. The search of a social media network computer system may include searching based on a data item of interest (e.g., a topic, an event, a category, etc.). A data item of interest may be identified by a user or an entity. The result of the search for the item of interest may determine the extent of the amount of content related to the data item of interest that exists on the social media network computer system within a set first time period. The extent of the content may be determined by either an amount or frequency of the content related to the data item of interest within a set first time period. Continuing the example above, the data item of interest that a user determines could be keynote speakers for the conference. Social media content over a set time period (e.g. the past two weeks) may be searched within one or more social media network computer systems to identify the frequency or amount of content directly associated with the keynote speakers. The extent of the content related to a keynote speaker for the event may be determined by computing the amount of such content or the frequency of such content present on the social media marketing networks.

According to embodiments of the disclosed subject matter, as shown at step 320, a determination may be made that the extent of the content, related to the data item of interest, within a time period, exceeds a relevancy threshold. The relevancy threshold may be determined in order to establish whether the extent of the content related to the item of interest is prominent enough to use such that a target audience will positively receive it. A user may determine the relevancy threshold. According to an embodiment of the disclosed subject matter, a user may be able to set a predetermined number of triggers associated with the data item of interest, the predetermined number of triggers establishing the threshold amount. As an example, a user may set the number of triggers to be 1000 mentions of a data item of interest within one day, where the 1000 mentions a day may be used as the threshold amount. The relevancy threshold may be based on either an amount or frequency of content present on one or more social media network computer systems. Notably, the level of interest and/or popularity of a data item of interest may be determined if the extent of the content surpasses the relevancy threshold. Continuing the previous example, a relevancy threshold could be set by the user based on a number of times a keynote speaker for the event is referenced. Alternatively, the relevancy threshold could be set based on the amount or frequency of other content relative to the amount of content involving the keynote speaker and the event. As a specific example, if the amount of total content on a social media platform is 45 gigabytes per hour, then the relevancy threshold may be 0.01% of the data per hour such that at least 4.5 megabytes of data must correspond to the data item of interest for the threshold to be met. If the content associated with a keynote speaker for the event is greater than the relevancy threshold, then a determination may be made that the keynote speaker is popular and that use of the keynote speaker's popularity may increase or enhance a campaign or promotion that is directed to the conference.

According to an embodiment of the disclosed subject matter, as shown at step 330, an electronic media item object, associated with the data item of interest, may be selected based on the extent of the content associated with the data item of interest being greater than the relevancy threshold. An electronic media item object may be any audio item, video item, image, text, or the like. Continuing the previous example, the content on a social media network computer system for a keynote speaker for a conference may exceed the relevancy threshold. Accordingly, an image (electronic media item object) of the keynote speaker may be obtained according to the techniques disclosed herein. The obtained electronic media item object may be publically available and a reduced cost or may be free of charge. Notably, an electronic media item object may be provided at a reduced or no cost and be very effective for promotion. The social media analysis (i.e., searching content in the social network computer system and determining the content exceeds a relevancy threshold) may indicate that the resulting electronic media item object will be popular or positively received.

In step 330, the electronic media item object may be selected according to the data item of interest by selecting the media item object by searching, for example, at least one of the repository of publicly-available images, the repository of images maintained by a third party company or individual, and a non-public repository of images maintained by a company having an association with the data item of interest. According to the subject of the data item of interest, as well as any comments, tagging, or other identifying marks from users of the social network computing system regarding the data item, an image repository can be searched for one or more images having at least one of a classification and metadata which most closely matches the data item of interest, as well as the comments, tagging, or other identifying marks affiliated with it. A threshold can be set as to the number of metadata items of a prospective image from at least one of the image repositories that match the data item of interest and the any of the comments, tagging, or other identifying marks associated therewith. An image can be selected, for example, that has the greatest number of matching items and that at least meets the threshold number.

According to an embodiment of the disclosed subject matter, as shown at step 340, the electronic media item object may be modified (e.g., automatically modified) such that a modified electronic media item object is generated. A modification may be any applicable modification that alters the electronic media item object including changing a format, preparing an electronic media item object for a promotion or delivery, filtering, editing, transforming, adding or removing sound, adding or removing media, adding or removing text, or the like. The modification may be made by a user or may be made automatically. An automated modification may include modifying an electronic media item object based on content from a social media network computer system (e.g. a post associated with the item of interest form a social network, a comment associated with a post for an item of interest, etc.). Continuing the previous example, if a specific keynote speaker was deemed popular based on social media triggers, then an image of the keynote speaker from a public server (e.g. a public/free server) may be obtained at no cost. The image may be received and modified. As a specific example, text corresponding to the keynote speaker may be contained in comments on a social media network computer system. The text from the comments may be extracted and placed onto the image. The image with the text may be used as an advertisement to promote the event.

According to embodiments of the disclosed subject matter, as shown at step 350, approval of a modified electronic media item object may be received. The approval may be by a user or may be automated such that the system automatically analyzes the modified electronic media item object and determines whether the modified electronic media item object is suitable for a given purpose. The given purpose may be for presentation, transmission, posting, or the like to one or more users, customers, or for a broadcast. The approval may be based on the content contained within the modified electronic media item object (e.g., analyzed for profanity or age appropriateness, spelling, grammar, etc.), the format, size, dimensions, or color of the media item. As an example, the modified electronic media item object may be provided to a targeted set of users via a social media platform of a social network computer system. Accordingly the dimensions for the modified electronic media item object may need to conform to the requirements of the social media platform of the social network computer system. Accordingly, if a modified electronic media item object does not conform to the size, it may be rejected. If the modified electronic media item object does conform to the size, then the modified electronic media item object may be approved. Continuing the previous example, the advertisement containing the keynote speaker as well as text may be submitted for approval. The submission may be to an automated system or to a content publishing supervisor who may automatically approve the image based on the content publishing rules. The approval may be provided based on the image with the text containing appropriate text and the proper dimensions.

According to embodiments of the disclosed subject matter, one or more targeted recipients may be identified at step 360 according to at least the approved modified electronic media item object and a database record including one or more recipient data. The one or more targeted recipients may be provided with the modified electronic media item object at step 370. A recipient may be identified as a target recipient based on recipient demographic information, recipient provided information, recipient actions, or the like. Demographic information may include, but is not limited to, age, gender, location, or any information that distinguishes a recipient from another recipient. The modified electronic media item object may be provided to the one or more identified target recipients via a communication channel (e.g., a social media network computer system, a user account, a SMS message, etc.). A recipient may be identified based on a database that contains recipient demographic information, recipient provided information, recipient actions or via one or more platforms (e.g., a social media network computer system, account settings, etc.). As an example, a modified electronic media item object may be sent to individuals on the East Coast of the United States. Users' email account information may contain information about respective user's location. Accordingly, a modified electronic media item object may be sent to the users that are located in the East Coast of the United States based on their email accounts. Continuing the previous example, the advertisement containing the keynote speaker and the text extracted from social media comments may be submitted for approval based on the dimensions of the advertisements. The system may analyze the dimensions and approve the advertisement based on the dimensions conforming to the limits set by the social media platform on which the advertisement is to be presented.

According to an embodiment of the disclosed subject matter, a modified electronic media item object may be monitored based on any applicable factor such as a conversion rate, a success rate, a response rate, or the like. Monitoring the modified electronic media item object may result in updating or further modifying the modified electronic media item object, based on the monitoring. The update or further modifying may result from a positive or negative response to the modified electronic media item object. An update to the modified electronic media item object may include providing the modified electronic media item object to a subset of users that are different than the targeted recipients that the modified electronic media item object was originally provided to. Alternatively, updating the modified electronic media may include changing an attribute of the electronic media item object such as a video attribute, audio attribute, text attribute, color attribute, or the like. Continuing the previous example, target recipients may be identified and sent the keynote speaker based advertisement. As a specific example, recipients who may have positively affirmed (e.g., promoted) the conference event on a social media network computer system may be the originally targeted recipients that received the advertisement. Alternatively, users who are between the ages of 20 and 30 and live in the area where the event is taking place or users who indicated that they attended the same event during a previous year may be the originally targeted recipients and may have received the advertisement. Monitoring the advertisement may result in identifying the advertisement as very effective such that it may be beneficial to further provide the advertisement to a larger subset of recipients. Accordingly, the advertisement may be provided to users between the age of 18 and 40.

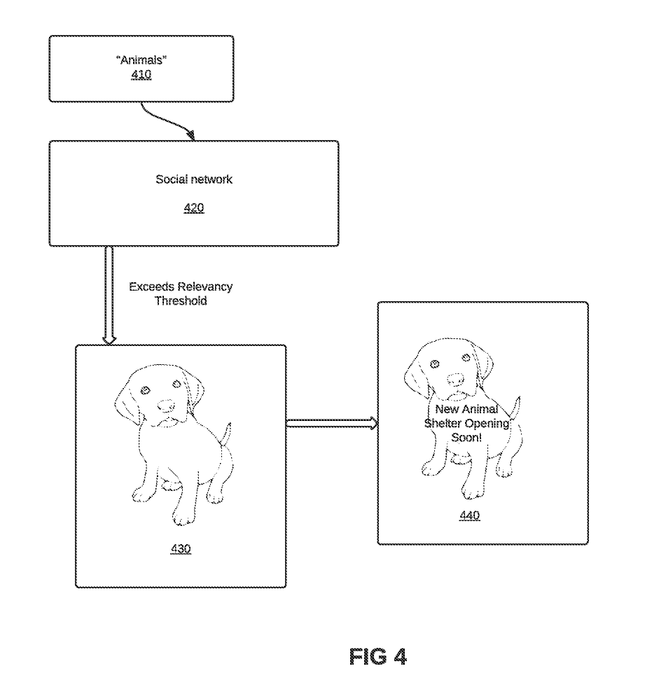

As an illustrative example of the disclosed subject matter, as shown in FIG. 4, a data item of interest corresponding to “Animals” may be identified at 410. The data item of interest may be searched for via a social network 420 such that content that relates to animals may be identified. If the number of occurrences of images, videos, or texts of dogs (i.e., related to animals) exceeds a predetermined threshold amount, then an image of a dog may be extracted, for example, from a free image database. Notably, the item of interest may be animals and content that mentions dogs in association with animals may exceed the predetermined threshold. The image of the dog may be modified at 440 such that text that advertises a “New Animal Shelter Opening Soon!” may be appended to the image. The modified image of the dog along with the text may be transmitted to all the users that commented, promoted, or published posts associated with animals on a social media network computer system.

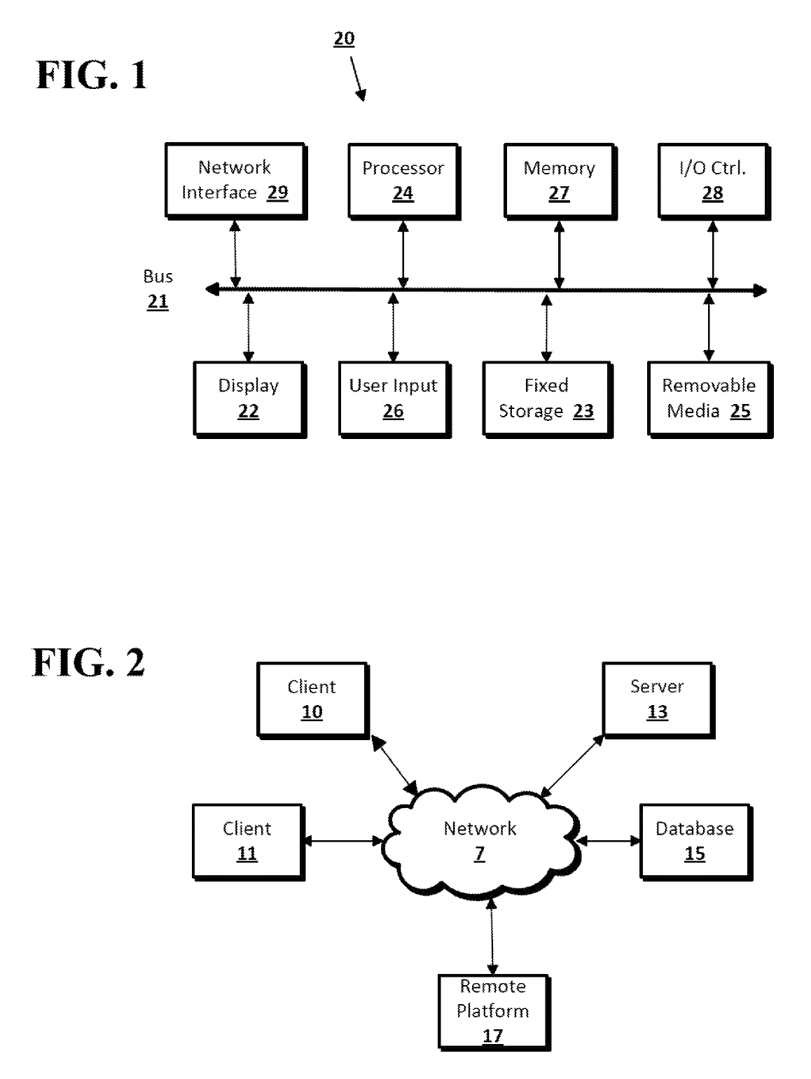

Implementations of the presently disclosed subject matter may be implemented in and used with a variety of component and network architectures. FIG. 1 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an embodiment of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method comprising:
searching content on a social network computer system for a data item of interest with an electronic media object generation system;
determining, within a first time period, when the content on the social network computer system related to the data item of interest exceeds a relevancy threshold set with the electronic media object generation system;
obtaining, with the media object generation system, an electronic media item object associated with the data item of interest from the social network computer system when the content exceeds the relevancy threshold;
automatically modifying the electronic media item object to generate a modified electronic media item object with the electronic media object generation system;
receiving, via an interface of the electronic media object generation system, approval of the modified electronic media item object;
identifying, with the electronic media object generation system, a targeted recipient according to at least the approved modified electronic media item object and a database record including one or more recipient data; and
providing, with the electronic media object generation system, the approved modified media item to the identified targeted recipient.

2. The method of claim 1, wherein the content on the social network computer system related to the data item of interest comprises at least one of an amount of the content present on the social network computer system within the first time period, and a frequency of the content present on the social network computer system within the first time period.

3. The method of claim 1, wherein the data item of interest is selected via the interface of the electronic media object generation system.

4. The method of claim 1, wherein the relevancy threshold is based on a number received from the interface of the electronic media object generation system, the number indicating a threshold amount of triggers associated with the data item of interest.

5. The method of claim 1, wherein the relevancy threshold is determined with the electronic media object generation system according to at least one of an amount of other content present on the social network computer system and a frequency of other content present on the social network computer system.

6. The method of claim 1, wherein the electronic media item object is publically available to at least the electronic media object generation system.

7. The method of claim 1, wherein the modifying the electronic media item object with the electronic media object generation system comprises adding social network comment data to the electronic media item object.

8. The method of claim 1, wherein the modifying the electronic media item object with the electronic media object generation system comprises adding user generated comment data to the electronic media item object.

9. The method of claim 1, wherein the approved modified media item object is generated automatically by the electronic media object generation system based on the modified electronic media item object.

10. The method of claim 1, wherein the targeted recipient is identified by the electronic media object generation system based on a recipient demographic.

11. The method of claim 1, wherein the targeted recipient is identified by the electronic media object generation system based on a recipient action.

12. The method of claim 1, further comprising providing the modified electronic media item object to the targeted recipient via a communication channel with the electronic media object generation system.

13. The method of claim 12, wherein the communication channel is at least one of a social network, a user account, and an SMS message.

14. The method of claim 1, further comprising monitoring the provided modified electronic media item object with the electronic media object generation system.

15. The method of claim 14, further comprising updating the modified media item object based on monitoring the provided electronic modified media item object with the electronic media object generation system.

16. A system comprising:
at least one database comprising a plurality of electronic media item objects and one or more recipient data;
a search apparatus configured to search content on a social network computer system for a data item of interest;
a processor configured to:
determine, within a first time period, when the content on the social network computer system related to the data item of interest exceeds a set relevancy threshold;
obtain an electronic media item object associated with the data item of interest from the social network computer system when the content exceeds the relevancy threshold;
automatically modify the electronic media item object to generate a modified electronic media item object;
receive, via an interface, approval of the modified electronic media item object;
identify a targeted recipient according to at least the approved modified electronic media item object and a database record from the at least one database including the one or more recipient data, and
provide the approved modified media item to the identified targeted recipient.

17. The system of claim 16, wherein the content on the social network computer system related to the item of interest comprises at least one of an amount of the content present on the social network computer system within the first time period, and a frequency of the content present on the social network computer system within the first time period.

18. The system of claim 16, wherein the data item of interest is selected via the interface.

19. The system of claim 16, wherein the relevancy threshold is based on a number received from the interface, the number indicating a threshold amount of triggers associated with the data item of interest.

20. The system of claim 16, wherein the relevancy threshold is determined according to at least one of an amount of other content present on the social network computer system and a frequency of other content present on the social network computer system.

21. The system of claim 16, wherein the electronic media item object is publically available.

22. The system of claim 16, wherein the modifying the electronic media item object by the processor comprises adding social network comment data to the electronic media item object.

23. The system of claim 16, wherein the modifying the electronic media item object with the processor comprises adding user generated comment data to the electronic media item object.

24. The system of claim 16, wherein the approval for the modified media content is generated automatically by the processor based on the modified electronic media item object.

25. The system of claim 16, wherein the targeted recipient is identified by the processor based on a recipient demographic.

26. The system of claim 16, wherein the targeted recipient is identified by the processor based on a recipient action.

27. The system of claim 16, further configured to provide the modified electronic media item object to the targeted recipient via a communication channel.

28. The method of claim 27, wherein the communication channel is at least one of a social network, a user account, and an SMS message.

29. The system of claim 16, wherein the processor is further configured to monitor the provided modified electronic media item object.

30. The method of claim 29, wherein the processor is further configured to update the modified electronic media item object based on monitoring the provided modified electronic media item object.
